(19) United States
(12) Patent Application Publication
(10) Pub. No.: US 2025/0063270 A1
(43) Pub. Date: Feb. 20, 2025

(54) IMAGE SENSING DEVICE AND IMAGING DEVICE INCLUDING THE SAME

(71) Applicant: SK hynix Inc., Gyeonggi-do (KR)

(72) Inventors: Seung Hwan LEE, Gyeonggi-do (KR); Jong Hyun RA, Gyeonggi-do (KR); Tae Kyoung JUNG, Gyeonggi-do (KR)

(21) Appl. No.: 18/801,828

(22) Filed: Aug. 13, 2024

(30) Foreign Application Priority Data
Aug. 18, 2023 (KR) 10-2023-0108391

(51) Int. Cl. H04N 25/77

(52) U.S. Cl. CPC H04N 25/77

(57) ABSTRACT

An image sensing device comprising, a latch array including, a first latch group, a second latch group, a first latch controller generates a first latch control signal to control the first latch group, and a second latch controller generates a second latch control signal to control the second latch group, wherein a second edge of the second latch control signal occurs after a first edge of the first latch control signal.

### CROSS-REFERENCE TO RELATED APPLICATION

This patent application claims the priority and benefits of Korean patent application No. 10-2023-0108391, filed on Aug. 18, 2023, the disclosure of which is incorporated herein by reference in its entirety.

### TECHNICAL FIELD

The embodiments of the present disclosure generally relate to technology capable of reducing power consumption of an image sensing device, and an imaging device including the image sensing device.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices is increasing in various fields such as smart phones, digital cameras, game machines, IoT (Internet of Things), robots, surveillance cameras and medical micro cameras.

Recently, the image sensing devices for providing high-quality images are becoming cheaper in cost, smaller in size, and larger in capacity. In addition, as consumers' demands for energy efficiency increase, research and development are being conducted to suppress unnecessary power consumption of high-performance image sensing devices.

### SUMMARY

Various embodiments of the present disclosure relate to an image sensing device designed to use a relatively small amount of power and an imaging device including the same.

In accordance with an embodiment of the present disclosure, an image sensing device may include a latch array including a first latch group configured to store first image data corresponding to a first region of a pixel array and a second latch group configured to store second image data corresponding to a second region of the pixel array; a first latch controller configured to generate a first latch control signal to control the first latch group; and a second latch controller configured to generate a second latch control signal to control the second latch group, wherein a time point where a second edge of the second latch control signal occurs is set to lag a time point where a first edge of the first latch control signal occurs.

In some embodiments, the first region may include a first column of the pixel array, and the second region may include a second column of the pixel array.

In some embodiments, the time point where the first edge occurs may refer to a time point where the first latch control signal transitions from a logic low level to a logic high level, and the time point where the second edge occurs may refer to a time point where the second latch control signal transitions from a logic low level to a logic high level.

In some embodiments, a pulse width of the first latch control signal and a pulse width of the second latch control signal may be different from each other.

In some embodiments, the first latch controller and the second latch controller may be activated by a same control start signal.

In some embodiments, the first latch controller may include a plurality of signal delay cells (i.e., buffer cells), each of which is configured to delay a start time of an input signal; and a variable switch configured to adjust a time point where an edge of the first latch control signal occurs such that different pixel groups included in the first region correspond to edges generated at different times.

In some embodiments, the variable switch may adjust the number of signal delay cells corresponding to the first region in response to a classification signal, and may thus adjust a time point where the edge of the first latch control signal occurs.

In some embodiments, the plurality of pixel groups may refer to pixel groups in which pixels electrically connected to the same analog-to-digital converter (ADC) are grouped.

In some embodiments, the plurality of pixel groups may refer to groups in which pixels corresponding to the same color are grouped.

In accordance with another embodiment of the present disclosure, an image signal device may include a latch array including a first latch group configured to store first image data corresponding to a first region of a pixel array and a second latch group configured to store second image data corresponding to a second region of the pixel array, wherein a time point where the second image data is stored in the second latch group is set to lag a time point where the first image data is stored in the first latch group.

In some embodiments, the first region may include a first column of the pixel array, and the second region may include a second column of the pixel array.

In some embodiments, the first latch group may be configured to receive a first latch control signal determining a storage start time of the first image data, and the second latch group may be configured to receive a second latch control signal determining a storage start time of the second image data.

In some embodiments, the first latch group may be configured to receive classification signals that adjust storage start times of different data groups included in the first image data such that the different data groups included in the first image data are stored at different time points.

In some embodiments, the classification signals may be configured to determine a storage start time of each of the plurality of data groups.

In some embodiments, the plurality of data groups may refer to data groups in which data pieces corresponding to the same analog-to-digital converter (ADC) are grouped.

In some embodiments, the plurality of data groups may refer to data groups in which pixel data pieces of pixels corresponding to the same color are grouped.

In accordance with another embodiment of the present disclosure, an image sensing method may include detecting, by a first latch group included in a latch array, a first edge of a first latch control signal; storing, by the first latch group, first image data corresponding to a first region of a pixel array; detecting, by a second latch group included in the latch array, a second edge of a second latch control signal; and storing, by the second latch group, second image data corresponding to a second region of the pixel array at a time point delayed from a storage time at which the first image data is stored.

In some embodiments, the storing the first image data corresponding to the first region of the pixel array may further include: receiving a first classification signal; and receiving a second classification signal.

In some embodiments, the receiving the first classification signal may include storing a first data group included in the first image data in response to the first classification signal.

In some embodiments, the receiving the second classification signal may include storing a second data group included in the first image data at a time point delayed from another time point where a first data group is stored.

It is to be understood that both the foregoing general description and the following detailed description of the present disclosure are illustrative, descriptive and are intended to provide further description of the embodiments of the present disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an imaging device based on some embodiments of the present disclosure.

FIG. 2 is a circuit diagram illustrating a pixel included in a pixel array shown in FIG. 1 based on some embodiments of the present disclosure.

FIG. 3 is a block diagram illustrating an analog-to-digital converter (ADC) shown in FIG. 1 based on some embodiments of the present disclosure.

FIG. 4 is a block diagram illustrating an example of a latch control unit and a latch array shown in FIG. 1 based on some embodiments of the present disclosure.

FIG. 5A is a logic circuit diagram illustrating the latch controllers shown in FIG. 4 based on some embodiments of the present disclosure.

FIG. 5B is a logic circuit diagram illustrating an example of the latch controllers shown in FIG. 4 based on some embodiments of the present disclosure.

FIG. 6 is a timing diagram illustrating operations of a first latch controller and a second latch controller shown in FIG. 5A based on some embodiments of the present disclosure.

FIGS. 7A to 7C are logic circuit diagrams and timing diagrams illustrating structures and operations of the latch controllers shown in FIG. 4 based on some embodiments of the present disclosure.

### DETAILED DESCRIPTION

The present disclosure provides embodiments and examples of an image sensing device capable of reducing power consumption of an image sensing device and an imaging device including the image sensing device, that may be used in configurations to substantially address one or more technical or engineering issues and to mitigate limitations or disadvantages encountered in some image sensing devices in the art. Some embodiments of the present disclosure relate to an image sensing device designed to use a relatively small amount of power and an imaging device including the same. In recognition of the issues above, the image sensing device based on some embodiments of the present disclosure can provide higher-quality images using a relatively small amount of power.

Reference will now be made in detail to some embodiments of the present disclosure which are illustrated in the accompanying drawings. Wherever possible, the same reference numbers will be used throughout the drawings to refer to the same or like parts. While this disclosure is susceptible to various modifications and alternative forms, specific embodiments thereof are shown by way of the drawings. However, the present disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the present disclosure may provide a variety of effects capable of being directly or indirectly recognized through the disclosed technology.

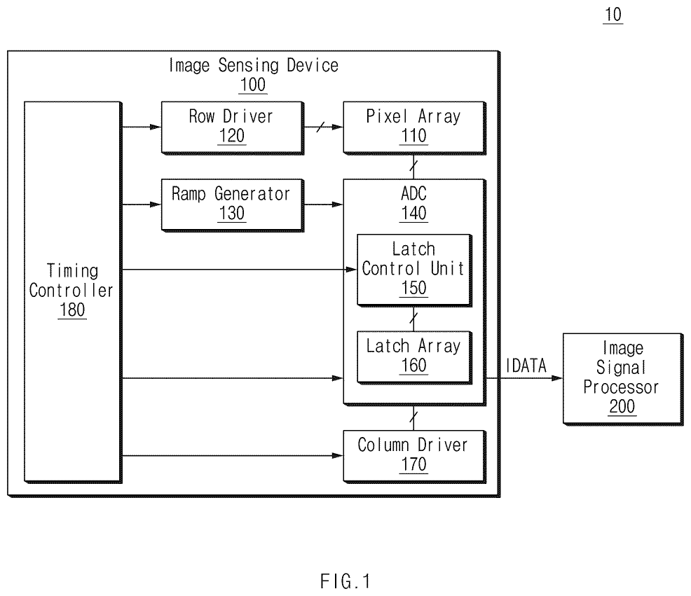

FIG. 1 is a block diagram illustrating an imaging device 10 based on some embodiments of the present disclosure.

Referring to FIG. 1, the imaging device 10 may be a device, for example, a digital still camera for photographing still images or a digital video camera for photographing moving images. For example, the imaging device 10 may be implemented as a Digital Single Lens Reflex (DSLR) camera, a mirrorless camera, a smartphone, and other similar devices. The imaging device 10 may include a device having both a lens and an image pickup element such that the device can capture (or photograph) a target object and can thus create an image of the target object.

The imaging device 10 may include an image sensing device 100 and an image signal processor (ISP) 200.

The image sensing device 100 may be a complementary metal oxide semiconductor image sensor (CIS) for converting incident light into an electrical signal. The image sensing device 100 may include a pixel array 110, a row driver 120, a ramp generator 130, an analog-digital converter (ADC) 140, a column driver 170, a timing controller 180, and a latch control unit 150 and a latch array 160 that are included in the ADC 140. The components of the image sensing device 100 illustrated in FIG. 1 may encompass numerous other changes, substitutions, variations, alterations, and modifications.

The pixel array 110 may include a plurality of unit imaging pixels arranged in rows and columns. For example, the plurality of unit imaging pixels can be arranged in a two dimensional pixel array including rows and columns. In another example, the plurality of unit imaging pixels can be arranged in a three-dimensional pixel array. The plurality of unit pixels may convert an optical signal into an electrical signal on a unit pixel basis or a pixel group basis, where unit pixels in a pixel group share at least certain internal circuitry. The pixel array 110 may receive driving signals, including a row selection signal, a pixel reset signal and a transfer signal, from the row driver 120. Upon receiving the driving signal, corresponding imaging pixels in the pixel array 110 may be activated to perform the operations corresponding to the row selection signal, the pixel reset signal, and the transfer signal.

The row driver 120 may activate the pixel array 110 to perform certain operations on the imaging pixels in the corresponding row based on commands and control signals provided by controller circuitry such as the timing controller 180. In some embodiments, the row driver 120 may select one or more imaging pixels arranged in one or more rows of the pixel array 110. The row driver 120 may generate a row selection signal to select one or more rows among the plurality of rows. The row driver 120 may sequentially enable the pixel reset signal for resetting imaging pixels corresponding to at least one selected row, and the transmission signal for the pixels corresponding to the at least one selected row. Thus, a reference signal and an image signal, which are analog signals generated by each of the imaging pixels of the selected row, may be sequentially transferred to the ADC 140. The reference signal may be an electrical signal that is provided to the ADC 140 when a sensing node of an imaging pixel (e.g., floating diffusion node) is reset, and the image signal may be an electrical signal that is provided to the ADC 140 when photocharges generated by the imaging pixel are accumulated in the sensing node. The reference signal indicating unique reset noise of each pixel and the image signal indicating the intensity of incident light may be generically called a pixel signal as necessary.

CMOS image sensors may use correlated double sampling (CDS) to remove undesired offset values of pixels known as the fixed pattern noise by sampling a pixel signal twice to remove the difference between these two samples. In one example, the correlated double sampling (CDS) may remove the undesired offset value of pixels by comparing pixel output voltages obtained before and after photocharges generated by incident light are accumulated in the sensing node so that only pixel output voltages based on the incident light can be measured. In some embodiments, the ADC 140 may sequentially sample and hold voltage levels of the reference signal and the image signal, which are provided to each of a plurality of column lines from the pixel array 110.

The ramp generator 130 may generate a ramp signal required for the analog-to-digital conversion operation of the ADC 140 under control of the timing controller 180, and may supply the ramp signal to the ADC 140.

The ADC 140 may sample and hold a pixel signal for each column output from each column line of the pixel array 110, may convert the pixel signal into a digital signal, and may output the digital signal. In some embodiments, the ADC 140 may be implemented as a ramp-compare type ADC. The ramp-compare type ADC may include a comparator circuit for comparing the analog pixel signal with the ramp signal that ramps up or down, and a timer for performing counting until a voltage of the ramp signal matches the analog pixel signal.

In some embodiments, the counter included in the ADC 140 may include a latch control unit 150. The latch control unit 150 may control a time point at which the latch array 160 stores the counting result generated by the counter 144. In some embodiments, the latch control unit 150 may differently adjust a time point of one edge of a latch control signal, and the latch array 160 may store the counting result generated by the counter 144 at the time point of one edge of the latch control signal, and the counting result stored in the latch array 160 may correspond to ADC data output from the ADC 140. For example, the latch array 160 may store the counting result generated by the counter 144 at the time point of the rising edge of the latch control signal, and the counting result stored in the latch array 160 may correspond to ADC data output from the ADC 140. In some embodiments, a rising edge may correspond to a signal from a logic low level to a logic high level.

In some embodiments, a counter included in the ADC 140 may include a latch array 160. The latch array 160 may receive image data (i.e., data IDATA obtained by digital conversion of the pixel signal) of each column unit from the ADC 140, and may temporarily hold the received image data (IDATA). The latch array 160 may temporarily store image data (IDATA) output from the ADC 140 based on a control signal of the timing controller 180. The image data temporarily stored in the latch array 160 may correspond to ADC data output from the ADC 140.

The column driver 170 may select a column of the latch array 160 based on a control signal of the timing controller 180, may temporarily store image data (IDATA) for the selected column of the latch array 160, and may control the latch array 160 to sequentially output the temporarily stored image data (IDATA). The output image data (IDATA) may correspond to ADC data. In some embodiments, the column driver 170 may receive an address signal from the timing controller 180, and may generate a column selection signal based on the address signal to select a column of the latch array 160. As a result, the column driver 170 may temporarily store the image data (IDATA) received from the selected column of the latch array 160, and may control the temporarily stored image data (IDATA) to be output to the outside. The output image data (IDATA) may correspond to ADC data. In some embodiments, the counting result generated by the counter 144 may correspond to image data (IDATA).

The timing controller 180 may control at least one of the row driver 120, the ramp generator 130, the ADC 140, the latch array 160, and the column driver 170.

The timing controller 180 may provide at least one of the row driver 120, the ramp generator 130, the ADC 140, the latch control unit 150, the latch array 160, and the column driver 170 with a clock signal required for the operations of the respective components of the image sensing device 100, a control signal for timing control, a row address signal for selecting a row, and a column address signal for selecting a column. In some embodiments, the timing controller 180 may include a logic control circuit, a phase lock loop (PLL) circuit, a timing control circuit, a communication interface circuit and others.

The image signal processor 200 may perform image processing of image data received from the image sensing device 100. The image signal processor 200 may reduce noise of image data, and may perform various types of image signal processing (e.g. interpolation, synthesis, gamma correction, color filter array interpolation, color matrix, color correction, color enhancement, lens distortion correction, etc.) for image-quality improvement of the image data. In addition, the image signal processor 200 may compress image data that has been created by execution of image signal processing for image-quality improvement, such that the image signal processor 200 can create an image file using the compressed image data. Alternatively, the image signal processor 200 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created. For example, the image files may be created according to Exchangeable image file format (Exif) standards.

When an error of the output signal of the ADC 140 occurs due to a delayed latch control signal, the image signal processor 200 may perform a post-processing operation for this error. For example, when the latch control signal is delayed as input to the latch array 160 by the latch control unit 150, errors may occur in an output signal that is output from the ADC 140 after being first temporarily stored in the latch array 160 of the ADC 140. To correct such errors, the image signal processor 200 may correct digital codes input to the latch array 160 based on a delay time of the latch control signal input to the latch array 160. In some embodiments, when the error caused by the delayed latch control signal is not completely offset (or cancelled), the image signal processor 200 may correct digital codes that were temporarily stored in the latch array 160 based on the latch control signal and an output signal of the counter.

The image signal processor 200 may transmit image data (hereinafter referred to as ‘ISP image data’) on which image processing has been completed to a host device (not shown). The host device (not shown) may be a processor (e.g., an application processor) for processing the ISP image data received from the image signal processor 200, a memory (e.g., a non-volatile memory) for storing the ISP image data, or a display device (e.g., a liquid crystal display LCD) for visually displaying the ISP image data.

In addition, the image signal processor 200 may transmit a control signal for controlling operations (whether or not to operate, an operation timing, an operation mode, etc.) of the image sensing device 100 to the image sensing device 100.

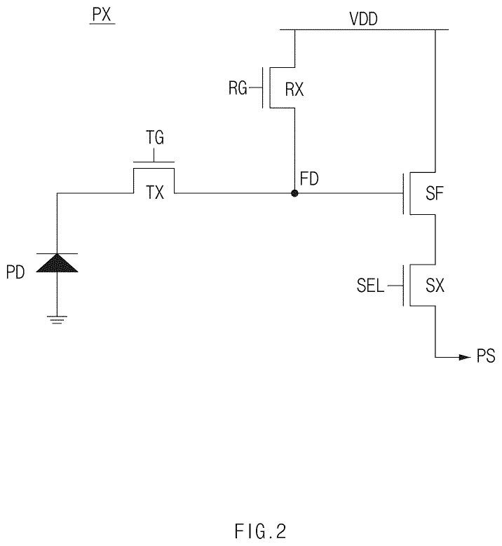

FIG. 2 is a circuit diagram illustrating a pixel (PX) included in the pixel array 110 shown in FIG. 1 based on some embodiments of the present disclosure.

Referring to FIG. 2, the pixel (PX) may be one of a plurality of pixels included in the pixel array 110. Although FIG. 2 shows only one pixel (PX) for convenience of description, other embodiments are also possible, and it should be noted that other pixels may also have substantially the same structure and operation as those of the pixel (PX).

The pixel (PX) may include a photoelectric conversion element (PD), a transfer transistor (TX), a reset transistor (RX), a floating diffusion region (FD), a source follower transistor (SF), and a selection transistor (SX). Although the pixel (PX) of FIG. 2 is illustrated as including only one photoelectric conversion element (PD) for convenience of description, other embodiments are also possible. Alternatively, the pixel (PX) of FIG. 2 may also be implemented as a shared pixel including a plurality of photoelectric conversion elements. In this case, a plurality of transfer transistors may be provided to correspond to a plurality of photoelectric conversion elements.

The photoelectric conversion element (PD) may generate and accumulate photocharges corresponding to the intensity of incident light through photoelectric conversion of the incident light. For example, the photoelectric conversion element (PD) may be implemented as a photodiode, a phototransistor, a photogate, a pinned photodiode or a combination thereof.

When the photoelectric conversion device (PD) is implemented as a photodiode, the photoelectric conversion element (PD) may be a region doped with impurities of a second conductivity type (e.g., N-type) in a substrate having a first conductivity type (e.g., P-type).

The transfer transistor (TX) may be connected between the photoelectric conversion element (PD) and the floating diffusion region (FD). The transfer transistor (TX) may be turned on or off in response to a transfer signal (TG), and the turned-on transfer transistor (TX) may transfer photocharges accumulated in the photoelectric conversion element (PD) to the floating diffusion region (FD).

The reset transistor (RX) may be connected between the power-supply voltage (VDD) and the floating diffusion area (FD), and may reset a voltage of the floating diffusion area (FD) to the power-supply voltage (VDD) in response to a pixel reset signal (RG).

The floating diffusion region (FD) may receive photocharges from the transfer transistor (TX). The floating diffusion region (FD) may be connected to a gate of the source follower transistor (SF), and may be referred to as a sensing node.

In some embodiments, a logic high level may be a voltage level for activating (e.g., turning on) a corresponding device (e.g., a transistor), and a logic low level may be a voltage level for deactivating (e.g., turning off) a corresponding device (e.g., a transistor).

The source follower transistor (SF) may be connected between the power-supply voltage (VDD) and the selection transistor (SX), may amplify a change in electrical potential of the floating diffusion region (FD) that has received photocharges accumulated in the photoelectric conversion element (PD), and may transmit the amplified result to the selection transistor (SX).

The selection transistor (SX) may be connected between the source follower transistor (SF) and the output signal line, and may be turned on by a selection control signal (SEL), so that the selection transistor (SX) can output the electrical signal received from the source follower transistor (SF) as a pixel signal (PS).

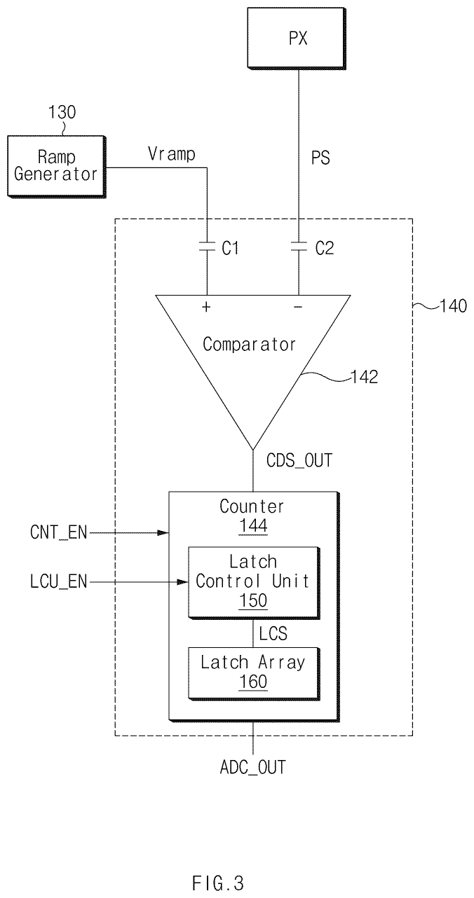

FIG. 3 is a block diagram illustrating the analog-to-digital converter (ADC) 140 shown in FIG. 1 based on some embodiments of the present disclosure.

Referring to FIG. 3, the ADC 140 may receive a ramp signal (Vᵣₐₘₚ) from the ramp generator 130, may receive a pixel signal (PS) from the pixel (PX), and may generate comparison data (CDS_OUT) corresponding to correlated double sampling (CDS) output data based on the ramp signal (Vᵣₐₘₚ) and the pixel signal (PS), such that the latch control unit 150 may generate a latch control signal (LCS) based on the comparison data (CDS_OUT). In addition, the ADC 140 may control a time point of storing the counting result in the latch array 160 based on the latch control signal (LCS), and may generate and output ADC data (ADC_OUT) based on data stored in the latch array 160.

The ADC 140 may include first and second capacitors (C1, C2), a comparator 142, and a counter 144.

The first capacitor C1 may receive the ramp signal (Vᵣₐₘₚ), and may transmit the ramp signal (Vᵣₐₘₚ) to the comparator 142. The second capacitor C2 may receive the pixel signal (PS), and may transmit the pixel signal (PS) to the comparator 142.

The comparator 142 may compare the ramp signal (Vᵣₐₘₚ) with the pixel signal (PS), may generate comparison data (CDS_OUT) according to the result of comparison, and may transmit the comparison data (CDS_OUT) to the counter 144. In some embodiments, when the ramp signal (Vᵣₐₘₚ) is greater than the pixel signal (PS), the comparator 142 may generate comparison data (CDS_OUT) of a logic high level. In addition, if the ramp signal (Vᵣₐₘₚ) is less than the pixel signal (PS), the comparator 142 may generate comparison data (CDS_OUT) of a logic low level. That is, the comparison data (CDS_OUT) may represent the magnitude relationship between the ramp signal (Vᵣₐₘₚ) and the pixel signal (PS).

The counter 144 may be activated in response to a counter enable signal (CNT_EN). The activated counter 144 may perform counting in response to the comparison data (CDS_OUT) of a logic high level, and may output the counting result as ADC data (ADC_OUT). Here, the ADC data (ADC_OUT) may correspond to image data (IDATA) described in FIG. 1. In some embodiments, the counter 144 may enable the latch control unit 150 to generate a latch control signal (LCS) based on comparison data (CDS_OUT), and may store the counting result in the latch array 160 based on the latch control signal (LCS).

The latch control unit 150 may be activated in response to a latch-control-unit enable signal (LCU_EN), and the activated latch control unit 150 may output the latch control signal (LCS) in response to comparison data (CDS_OUT) of a logic high level. In some embodiments, the latch control unit 150 may receive the comparison data (CDS_OUT) from the comparator 142, and may generate and output a latch control signal LCS based on the comparison data (CDS_OUT). In some embodiments, the latch control signal (LCS) may control a time point of storing the counting result in the latch array, and the result stored in the latch array may correspond to ADC data (ADC_OUT) output from the ADC 140.

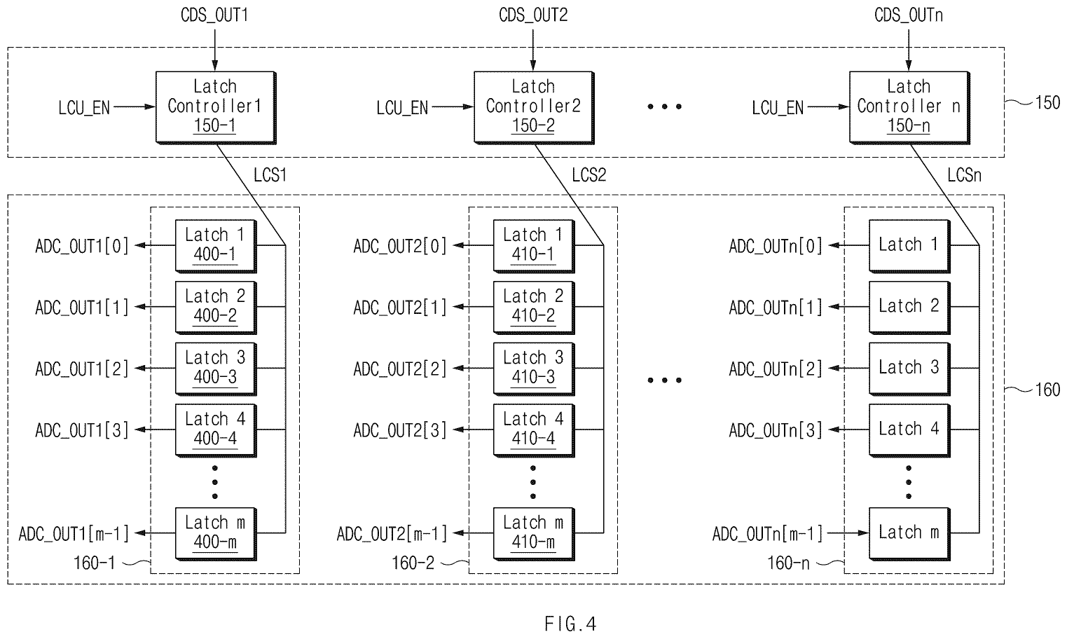

FIG. 4 is a block diagram illustrating the latch control unit 150 and the latch array 160 shown in FIG. 1 based on some embodiments of the present disclosure.

Referring to FIG. 4, the latch control unit 150 may include latch controllers (e.g., 150-1, 150-2, and 150-n) respectively corresponding to columns of the pixel array 110. Here, the latch array 160 may include latch groups (e.g., 160-1, 160-2, and 160-n) that are electrically connected to the latch controllers (e.g., 150-1, 150-2, and 150-n), respectively.

Each column of the pixel array 110 may correspond to one latch controller. In some embodiments, a signal output from a pixel belonging to a first column corresponding to the latch controller (e.g., 150-1) may be used to generate comparison data (CDS_OUT) through the ADC 140. At this time, the latch controller (e.g., 150-1) may receive the generated comparison data (CDS_OUT). In some implementations, each column may correspond to one latch controller. For example, a first column of the pixel array 110 may correspond to the first latch controller 150-1, and a second column of the pixel array 110 may correspond to the second latch controller 150-2. In some other embodiments, a plurality of columns may correspond to one latch controller. For example, odd-numbered columns may correspond to the first latch controller 150-1, and even-numbered columns may correspond to the second latch controller 150-2.

The latch control unit 150 may receive a plurality of comparison data (e.g., CDS_OUT-1, CDS_OUT-2, CDS_OUT-n) respectively corresponding to columns of the pixel array 110, and may generate and output latch control signals (e.g., LCS1, LCS2, LCSn) based on the comparison data. For example, the first latch controller 150-1 may receive first comparison data (CDS_OUT-1) corresponding to the first column, and may generate and output a first latch control signal (LCS1).

The latch array 160 may store the results counted by the counter 144 in response to latch control signals (e.g., LCS1, LCS2, LCSn) respectively corresponding to the columns of the pixel array 110, and the counter 144 may output a plurality of ADC data (e.g., ADC_OUT1, ADC_OUT2, ADC_OUTn) for each column based on the stored counting results. For example, a first latch group 160-1 electrically connected to the first latch controller 150-1 may store the counting data of the first column in the order of digital codes in response to the first latch control signal (LCS1). Here, the stored counting data of the first column may correspond to the first ADC data (ADC_OUT1).

In some embodiments, the first latch controller 150-1 may correspond to the first column of the pixel array 110. In the ADC 140, the comparator (e.g., 142 of FIG. 3) may generate first comparison data (CDS_OUT1) by comparing the pixel data of the pixels included in the first column of the pixel array 110 with the ramp signal. Additionally, in the ADC 140, the first comparison data (CDS_OUT1) may be converted into first ADC data (ADC_OUT1) through a counter (e.g., 144 in FIG. 3). At this time, the first latch controller 150-1 may receive the latch-control-unit enable signal (LCU_EN) and the first comparison data (CDS_OUT1) to generate the first latch control signal (LCS1). The first latch group 160-1 may receive the first latch control signal (LCS1), and may store the counting data of the first column at the rising edge of the first latch control signal (LCS1). The stored counting data of the first column may be output as first ADC data (ADC_OUT1).

For example, the first latch group 160-1 may include a plurality of latches (Latch 1 (400-1)˜Latch m (400-m)). When the rising edge of the first latch control signal (LCS1) is detected, the first latch group 160-1 may store, in the latch 1 (400-1), data located at a first position of the counting data corresponding to a first column. When the rising edge of the first latch control signal (LCS1) is detected, the first latch group 160-1 may store, in the latch 2 (400-2), data located at a second position of the counting data of the first column. Likewise, data (ADC_OUT1[2]) located in a third position of the counting data of the first column may be stored in the latch 3 (400-3). The number of digits of the ADC data (ADC_OUT1) may be less than the number of latches (e.g., m) included in the latch group (e.g., 160-1). The above-described embodiment may also be applied to the second column of the pixel array 110 and the second latch group 160-2 corresponding to the second latch controller 150-2.

In some embodiments, the counting data of the first column stored in the latches (Latch 1 (400-1)˜Latch n (400-n)) of the first latch group 160-1 may correspond to the first ADC data (ADC_OUT1).

In some other embodiments, the latch array 160 may store the counting results counted by the counter 144 in response to latch control signals respectively corresponding to the plurality of columns of the pixel array 110, and the counter 144 can output a plurality of ADC data for each column based on the stored counting results. For example, a latch group electrically connected to the latch controllers may store the counting data of a plurality of columns in the order of digital codes in response to the latch control signals, and the stored counting data of the plurality of columns may be converted into ADC data corresponding thereto.

In some other embodiments, a first complex latch controller (not shown) may correspond to a plurality of columns of the pixel array 110. For example, the comparator (e.g., 142 in FIG. 3) of the ADC 140 may compare the pixel data of the pixels included in the first and second columns of the pixel array 110 with the ramp signal, and may generate first comparison data (CDS_OUT1) and second comparison data (CDS_OUT2) based on the result of comparison. In addition, in the ADC 140, the first comparison data (CDS_OUT1) may be converted into the first ADC data (ADC_OUT1) through a counter (e.g., 144 in FIG. 3), and the second comparison data (CDS_OUT2) may be converted into the second ADC data (ADC_OUT2) through a counter (e.g., 144 in FIG. 3). In this case, a first complex latch controller (not shown) may receive a latch-control-unit enable signal (LCU_EN), first comparison data (CDS_OUT1), and second comparison data (CDS_OUT2), and may generate a first complex latch control signal (not shown). The first latch group 160-1 and the second latch group 160-2 may receive a first complex latch control signal (not shown), and may store a counting result corresponding to the first comparison data (CDS_OUT1) and a counting result corresponding to the second comparison data (CDS_OUT2) at a time point of a rising edge of the first complex latch control signal (not shown). In some embodiments, the counting result corresponding to the first comparison data (CDS_OUT1) and the counting result corresponding to the second comparison data (CDS_OUT2) may correspond to the first ADC data (ADC_OUT1) and the second ADC data (ADC_OUT2), respectively.

For example, the first latch group 160-1 may include a plurality of latches (Latch 1 (400-1) to Latch m (400-m)). When a rising edge of the first complex latch control signal (not shown) is detected, the first latch group 160-1 may store, in the latch 1 (400-1), data located at a first position of the counting data corresponding to the first column. When a rising edge of the first complex latch control signal (not shown) is detected, the first latch group 160-1 may store, in the latch 2 (400-2), data located at a second position of the counting data corresponding to the first column. Likewise, data (ADC_OUT1[2]) located in a third position of the counting data corresponding to the first column may be stored in the latch 3 (400-3). In addition, the second latch group 160-2 may include a plurality of latches (Latch 1 (410-1)˜Latch m (410-m)). When the rising edge of the first complex latch control signal (not shown) is detected, the second latch group 160-2 may store, in the latch 1 (400-1), data located at a first position of the counting data corresponding to a second column. When the rising edge of the first complex latch control signal (not shown) is detected, the second latch group 160-2 may store, in the latch 2 (410-2), data (ADC_OUT2[1]) located at a second position of the counting data corresponding to the second column. Likewise, data (ADC_OUT2[2]) located in a third position of the counting data corresponding to the second column may be stored in the latch 3 (410-3). The number of digits of the first ADC data (ADC_OUT1) may be less than the number of latches (e.g., m) included in the latch group (e.g., 160-1), and the number of digits of the second ADC data (ADC_OUT2) may be less than the number of latches (e.g., m) included in the latch group (e.g., 160-2). The above-described embodiment can also be applied not only to the third and fourth columns of the pixel array 110 corresponding to the second complex latch controller (not shown), but also to the third latch group 160-3 and the fourth latch group (not shown) of the pixel array 110.

In some embodiments, the counting data of the first column stored in the latches (Latch 1 (400-1)˜Latch m (400-m)) and the counting data of the second column stored in the latches (Latch 1 (410-1)˜Latch m (410-m)) may correspond to the first ADC data (ADC_OUT1) and the second ADC data (ADC_OUT2), respectively.

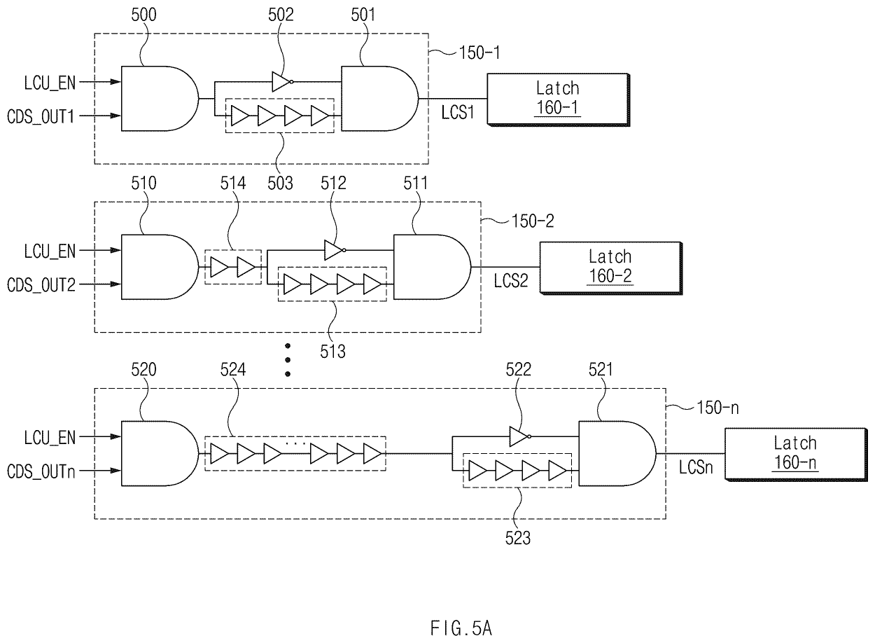

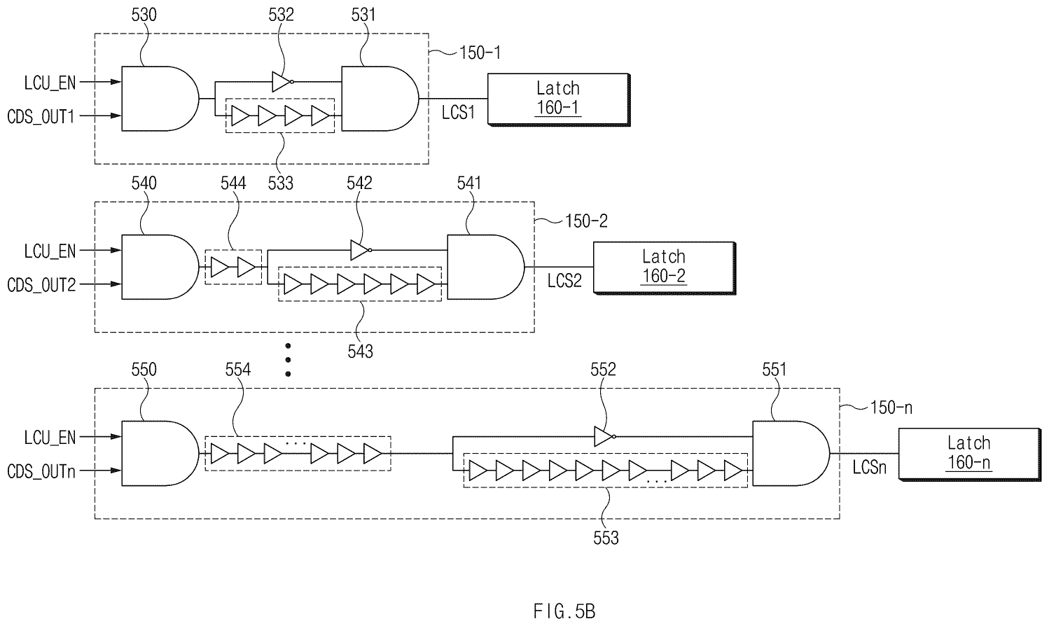

FIG. 5A is a logic circuit diagram illustrating the latch controllers shown in FIG. 4 based on some embodiments of the present disclosure.

Referring to FIG. 5A, the latch controllers (e.g., 150-1, 150-2, and 150-n) may respectively receive the latch-control-unit enable signal (LCU_EN) and the comparison data (e.g., CDS_OUT1, CDS_OUT2, CDS_OUTn), and may respectively output the latch control signals (e.g., LCS1, LCS2, LCSn). In more detail, the latch controller (150-1) may receive the latch-control-unit enable signal (LCU_EN) and the comparison data (CDS_OUT1) to output the latch control signal (LCS1), the latch controller (150-2) may receive the latch-control-unit enable signal (LCU_EN) and the comparison data (CDS_OUT2) to output the latch control signal (LCS2), and the latch controller (150-n) may receive the latch-control-unit enable signal (LCU_EN) and the comparison data (CDS_OUTn) to output the latch control signal (LCSn).

The latch controllers (e.g., 150-1, 150-2, 150-n) may include different logic circuit structures. In some embodiments, the latch controllers (e.g., 150-1, 150-2, 150-n) may include at least one of logical product elements (e.g., 500, 510, 520), at least one of logical negation elements (e.g., 502, 512, 522), and at least one of signal delay cells (e.g., 503, 513, 514, 523, 524). For example, the first latch controller 150-1 may include two logical product elements (500, 501), one logical negation element 502, and four signal delay cells 503, and the second latch controller 150-2 may include two more signal delay cells 514 than the first latch controller 150-1.

In some embodiments, a second edge of the second latch control signal (LCS2) may be later than a first edge of the first latch control signal (LCS1). For example, the rising edge of the second latch control signal (LCS2) may be later than the rising edge of the first latch control signal (LCS1). In some embodiments, the first edge may correspond to at least one rising edge of the first latch control signal, and the second edge may correspond to at least one rising edge of the second latch control signal.

The latch groups (e.g., 160-1, 160-2, 160-n) may store the counting results respectively corresponding to comparison data (e.g., CDS_OUT1, CDS_OUT2, CDS_OUTn) at a time point of the rising edge of latch control signals (e.g., LCS1, LCS2, LCSn). The counting results corresponding to the plurality of comparison data may correspond to ADC data (e.g., ADC_OUT1, ADC_OUT2, ADC_OUT3), respectively. For example, when the rising edge of the first latch control signal (LCS1) occurs, the first latch group 160-1 may store the counting data of the first column at the corresponding bit position according to the order of digital codes, and the stored counting data of the first column may correspond to the first ADC data (ADC_OUT1).

In some embodiments, as can be seen from the first latch controller 150-1, an input terminal of the logical negation element 502 may be connected to an output terminal of the first logical product element 500, and an output terminal of the logical negation element 502 may be connected to a first input terminal of the second logical product element 501. In addition, the input terminal of the signal delay cell 503 may be connected to the output terminal of the first logical product element 500, and the output terminal of the signal delay cell 503 may be connected to the second input terminal of the second logical product element 501.

In some embodiments, the first latch controller 150-1 may perform the following operations. When the latch-control-unit enable signal (LCU_EN) is kept at a logic high level and the first comparison data (CDS_OUT1) transitions from a logic high level to a logic low level, the output signal of the first logical product element 500 may transition from a logic high level to a logic low level. At the same time (i.e., when the latch-control-unit enable signal (LCU_EN) is kept at a logic high level and the first comparison data (CDS_OUT1) transitions from a logic high level to a logic low level), the output signal of the logical negation element 502 may transition from a logic low level to a logic high level. Further, the output signal of the signal delay cell 503 may transition from a logic high level to a logic low level at a unit time amount after the transition of the output signal of the logical negation element 502, the unit time amount being defined by the signal delay cell 503 . . . . In this process, since the logical negation element 502 and the signal delay cell 503 of the second logical product element 501 simultaneously have a logic high level during the unit time amount defined by the signal delay cell 503, the first latch control signal (LCS1) may appear as a pulse-shaped signal having a rising edge and a falling edge. In some embodiments, falling edge may correspond to a signal from a logic high level to a logic low level.

In some embodiments, as can be seen from the second latch controller 150-2, the input terminal of the additional signal delay cell 514 may be connected to the first logical product element 510, and the output terminal of the additional signal delay cell 514 may be connected to the input terminal of the logical negation element 512 and the input terminal of the signal delay cell 513, differently from the first latch controller 150-1.

In some embodiments, the second latch controller 150-2 may perform the following operations. When the latch-control-unit enable signal (LCU_EN) is kept at a logic high level and the second comparison data (CDS_OUT2) transitions from the logic high level to the logic low level, the output signal of the first logical product element 510 may transition from the logic high level to the logic low level. After a unit time amount defined by the additional signal delay cell 514, the output signal of the logical negation element 512 may transition from the logic low level to the logic high level. Further, the output signal of the signal delay cell 513 may transition from the logic high level to the logic low level at the unit time amount after the transition of the output signal of the logical negation element 512, the unit time amount being defined by the signal delay cell 513. In this process, since the logical negation element 512 and the signal delay cell 513 simultaneously have a logic high level during the unit time amount defined by the signal delay cell 513, the second latch control signal (LCS2) of the second logical product element 511 may appear as a pulse-shaped signal having a rising edge and a falling edge.

In some embodiments, as can be seen from the N-th latch controller (150-n), the input terminal of the additional signal delay cell 524 may be connected to a first logic product element 520, and the output terminal of the additional signal delay cell 524 may be connected to the input terminal of the logic negation element 522 and the input terminal of the signal delay cell 523, differently from the first latch controller 150-1. The additional signal delay cell 524 may include 2 (n−1) signal delay buffer cells.

FIG. 5B is a logic circuit diagram illustrating the latch controllers shown in FIG. 4 based on some embodiments of the present disclosure.

Referring to FIG. 5B, the latch controllers (e.g., 150-1, 150-2, 150-n) may receive the latch-control-unit enable signal (LCU_EN) and the comparison data (e.g., CDS_OUT-1, CDS_OUT-2, CDS_OUT-n), respectively, and may output the latch control signals (e.g., LCS1, LCS2, LCSn), respectively.

The latch controllers (e.g., 150-1, 150-2, 150-n) may include different logic circuit structures. In some embodiments, the latch controllers may include at least one of logical product elements (e.g., 530, 531, 540, 541, 550, 551), at least one of logical negation elements (e.g., 532, 542, 552), and at least one of signal delay cells (e.g., 533, 543, 544, 553, 554). For example, the first latch controller 150-1 may include two logical product elements (two AND gates), one logical negation element (one NOT gate), and four signal delay cells (four buffer cells). The second latch controller 150-2 may include four more signal delay cells (four buffer cells) than the first latch controller 150-1. Two of the four signal delay cells (four buffer cells) may be connected in series to the logical negation element (NOT gate), and the remaining two signal delay cells may be connected in parallel to the logical negation element (NOT gate).

In some implementations, the second edge of the second latch control signal (LCS2) may be later than the first edge of the first latch control signal (LCS1). For example, the rising edge of the second latch control signal (LCS2) may be later than the rising edge of the first latch control signal (LCS1) and the falling edge of the second latch control signal (LCS2) may be later than the falling edge of the first latch control signal (LCS1).

The latch groups (e.g., 160-1, 160-2, 160-n) may store the counting results corresponding to comparison data (e.g., CDS_OUT1, CDS_OUT2, CDS_OUTn) at a time point of the rising edge of the latch control signals (e.g., LCS1, LCS2, LCSn). In this case, the counting result corresponding to such comparison data may correspond to ADC data (e.g., ADC_OUT1, ADC_OUT2, ADC_OUT3). For example, when the rising edge of the first latch control signal (LCS1) occurs, the first latch group 160-1 may store the counting data of the first column at the corresponding bit position according to the order of digital codes. The stored counting data of the first column may correspond to the first ADC data (ADC_OUT1).

In some embodiments, as can be seen from the first latch controller 150-1, the input terminal of the logical negation element 532 may be connected to the output terminal of the first logical product element 530, and the output terminal of the logical negation element 532 may be connected to the first input terminal of the second logical product element 531. In addition, the input terminal of the signal delay cell 533 may be connected to the output terminal of the first logical product element 530, and the output terminal of the signal delay cell 533 may be connected to the second input terminal of the second logical product element 531.

In some embodiments, the first latch controller 150-1 may perform the following operations. When the latch-control-unit enable signal (LCU_EN) is kept at the logic high level and the first comparison data (CDS_OUT1) transitions from the logic high level to the logic low level, the output signal of the first logical product element 530 may transition from the logic high level to the logic low level. At the same time (i.e., when the latch-control-unit enable signal (LCU_EN) is kept at the logic high level and the first comparison data (CDS_OUT1) transitions from the logic high level to the logic low level), the output signal of the logical negation element 532 may transition from the logic low level to the logic high level. Further, the output signal of the signal delay cell 533 may transition from the logic high level to the logic low level at a unit time amount after the transition of the output signal of the logical negation element 532, the unit time amount being defined by the signal delay cell 533. In this process, since the logical negation element 532 and the signal delay cell 533 simultaneously have a logic high level during the unit time amount defined by the signal delay cell 533, the first latch control signal (LCS1) of the second logical product element 531 may appear as a pulse-shaped signal having a rising edge and a falling edge.

In some embodiments, as can be seen from the second latch controller 150-2, the signal delay cell 543 may include two more signal delay buffer cells, the input terminal of the additional signal delay cell 544 may be connected to the first logical product element 540, and the output terminal of the additional signal delay cell 544 may be connected to the input terminal of the logical negation element 542 and the input terminal of the signal delay cell 543, differently from the first latch controller 150-1.

In some embodiments, the second latch controller 150-2 may perform the following operations. When the latch-control-unit enable signal (LCU_EN) is kept at the logic high level and the second comparison data (CDS_OUT2) transitions from the logic high level to the logic low level, the output signal of the first logical product element 540 may transition from the logic high level to the logic low level. After a unit time amount defined by the additional signal delay cell 544, the output signal of the logical negation element 542 may transition from the logic low level to the logic high level. Further, the output signal of the signal delay cell 543 may transition from the logic high level to the logic low level at the unit time amount after the transition of the output signal of the logical negation element 542, the unit time amount being defined by the signal delay cell 543. In this process, since the logical negation element 542 and the signal delay cell 543 simultaneously have a logic high level during the unit time amount defined by the signal delay cell 543, the second latch control signal (LCS2) of the second logical product element 541 may output a pulse-shaped signal having a rising edge and a falling edge.

In some embodiments, as can be seen from the N-th latch controller (150-n), the signal delay cell 553 may include 2(n−1) more signal delay buffer cells than the first latch controller 150-1, an input terminal of the additional signal delay cell 554 may be connected to the first logical product element 550, and an output terminal of the additional signal delay cell 554 may be connected to the input terminal of the logic negation element 554 and the input terminal of the signal delay cell 553, differently from the first latch controller 150-1. The additional signal delay cell 554 may include 2(n−1) signal delay buffer cells.

In some embodiments, the falling edge of the second latch control signal (LCS2) may be later than the falling edge of the first latch control signal (LCS1). For example, the falling edge of the output signal of the signal delay cell 543 of the second latch controller 150-2 may be later by a delay time amount than the falling edge of the signal of the signal delay cell 533 of the first latch controller 150-1, the delay time amount being defined by two signal delay buffer cells. In this case, the pulse width of the second latch control signal (LCS2) may be larger than the pulse width of the first latch control signal (LCS1).

In some embodiments, a pulse width of the first latch control signal (LCS1) or a pulse width of the second latch control signal (LCS2) may be adjusted to control a level of voltage to be supplied to the first latch group 160-1 or a level of voltage to be supplied to the second latch group 160-2. For example, when a voltage is supplied to the counter 144 through both left and right ends of the counter 144, a voltage level may decrease in response to flow of current. As a result, a supply voltage level may gradually decrease from one of the latches located at both ends of the latch array 160 to the center latch (e.g., 160-2). For example, since the first latch group 160-1 has a high supply voltage level, the first latch group 160-1 can store data even when the pulse width of the first latch control signal (LCS1) has a short pulse width. In contrast, since the second latch group 160-2 has a low supply voltage level, the second latch group 160-2 may not store data when the pulse width of the second latch control signal (LCS2) has a short pulse width. In this case, when the pulse width of the first latch control signal (LCS1) is set to a small width and the pulse width of the second latch control signal (LCS2) is set to a large width, power consumption required to operate the counter 144 can be optimized.

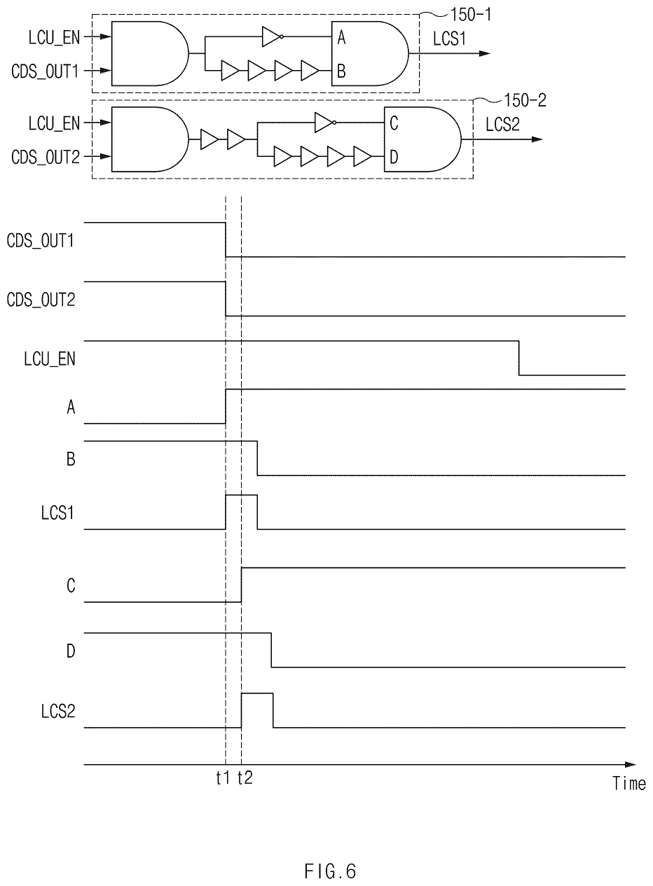

FIG. 6 is a timing diagram illustrating operations of the first latch controller and the second latch controller shown in FIG. 5A based on some embodiments of the present disclosure.

Referring to FIG. 6, each of the latch control signals (e.g., LCS1, LCS2) may transition from a logic low level to a logic high level. In addition, a signal generated when each latch control signal transitions from a logic low level to a logic high level may be defined as a rising edge of the signal, and a signal generated when each latch control signal transitions from a logic high level to a logic low level may be defined as a falling edge of the signal.

While the latch-control-unit enable signal (LCU_EN) has a logic high level, the first comparison data (CDS_OUT1) and the second comparison data (CDS_OUT2) simultaneously transition from a logic high level to a logic low level. Here, the rising edge or the falling edge of the latch control signals (e.g., LCS1, LCS2) may occur through the logical negation elements (e.g., 502 and 512 of FIG. 5A), the signal delay cells (e.g., 503, 513 and 514 of FIG. 5A), and the logical product elements (e.g., 500, 501, 510, and 511 of FIG. 5A).

In some embodiments, when the latch-control-unit enable signal (LCU_EN) has a logic high level and the first comparison data (CDS_OUT1) has a logic high level, the terminal (A) may have a logic low level due to the logical negation element (e.g., 502 of FIG. 5A) and the terminal (B) may have a logic high level due to the logical negation element (e.g., 502 of FIG. 5A). Thereafter, when the first comparison data (CDS_OUT1) transitions from a logic high level to a logic low level, the terminal (A) may immediately have a logic high level. Further, the terminal (B) may have a logic low level at a unit time amount after the terminal (A) becomes to have a logic high level, the unit time amount being defined by four signal delay cells (e.g., 503 of FIG. 5A). When the signal input to the terminal (A) and the signal input to the terminal (B) are input to the logical product element (e.g., 501 of FIG. 5A), the first latch control signal (LCS1) may transition from the logic low level to the logic high level (i.e., transitions to a rising edge) at a time point (t1) where the terminal (A) transitions to the logic high level (i.e., a rising edge), and may transition from the logic high level to the logic low level (i.e., a falling edge) at a time point where the terminal (B) transitions to the logic low level (i.e., a falling edge).

In some embodiments, when the latch-control-unit enable signal (LCU_EN) has a logic high level and the second comparison data (CDS_OUT2) has a logic high level, the terminal (C) may have a logic low level due to the logical negation element (e.g., 512 of FIG. 5A), and may have a logic high level due to the logical negation element (e.g., 512 of FIG. 5A). Thereafter, the terminal (C) may have a logic high level at a delay time amount after the second comparison data (CDS_OUT2) transitions from a logic high level to a logic low level, the delay time amount being defined by two signal delay cells due to two signal delay cells (e.g., 514 of FIG. 5A). Further, the terminal (D) may have a logic low level at a delay time amount after the second comparison data (CDS_OUT2) transitions from a logic high level to a logic low level, the delay time amount being defined by 6 signal delay cells due to two signal delay cells, which are serially coupled to each other, and four signal delay cells, which are serially coupled to each other. When the signal input to the terminal (C) and the signal input to the terminal (D) are input to the logical product element (e.g., 511 of FIG. 5A), the second latch control signal (LCS2) may transition from the logic low level to the logic high level (i.e., a rising edge) at a time point (t2) where the node (C) transitions to a logic high level (i.e., a rising edge), and may transition from the logic high level to the logic low level (i.e., a falling edge) at a time point where the node (D) transitions to a logic low level (i.e., a falling edge).

In some embodiments, each latch group (e.g., 160-1, 160-2, and 160-n of FIG. 4) may store the counting result at a time point (e.g., t1, t2) of the rising edge of each of the latch control signals (e.g., LCS1, LCS2), and the ADC 140 may output the stored counting result as the ADC data. For example, referring again to FIG. 4, at the time point (t1) of the rising edge of the first latch control signal (LCS1), the first latch group 160-1 may include a plurality of latches (Latch 1 (400-1)˜Latch m (400-m)). At the time point of the rising edge of the first latch control signal (LCS1), the latch 1 (400-1) of the first latch group 160-1 may store data located at a first position of the counting data of the first column, and the latch 2 (400-2) of the first latch group 160-1 may store data located at a second position of the counting data of the first column. Similarly, data located at a third position of the counting data of the first column may be stored in the latch 3 (400-3). The number of digits of the ADC data (ADC_OUT1) may be less than the number of latches (e.g., m) included in the latch group (e.g., 160-1). The above-described embodiment can also be applied not only to the second column of the pixel array 110 corresponding to the second latch controller 150-1, but also to the second latch group 160-2.

In some embodiments, the first edge of the first latch control signal (LCS1) and the second edge of the second latch control signal (LCS2) occur at different time points and therefore the time points of storing data in the respective first and second latch groups become different from each other. As a result, a peak current flowing in the imaging device 10 can be reduced.

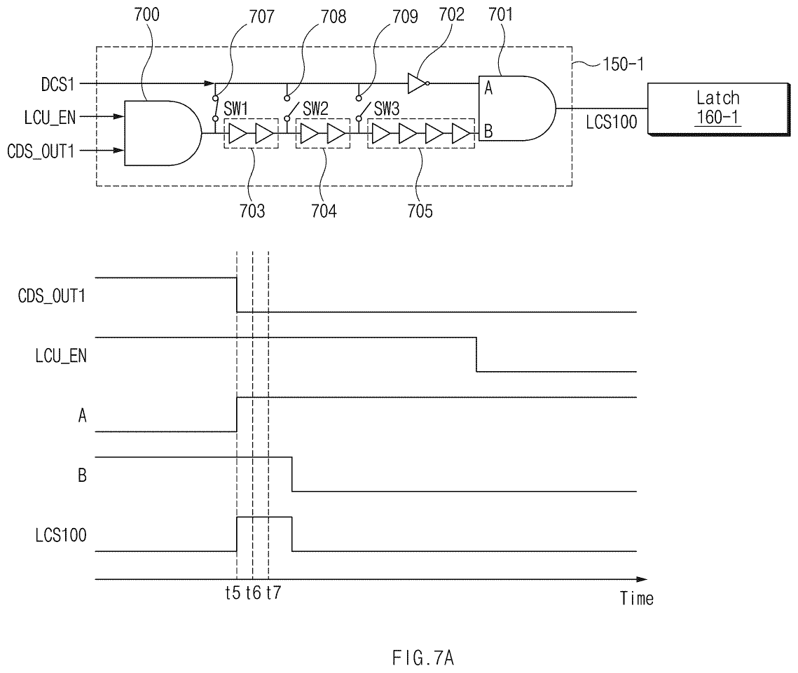

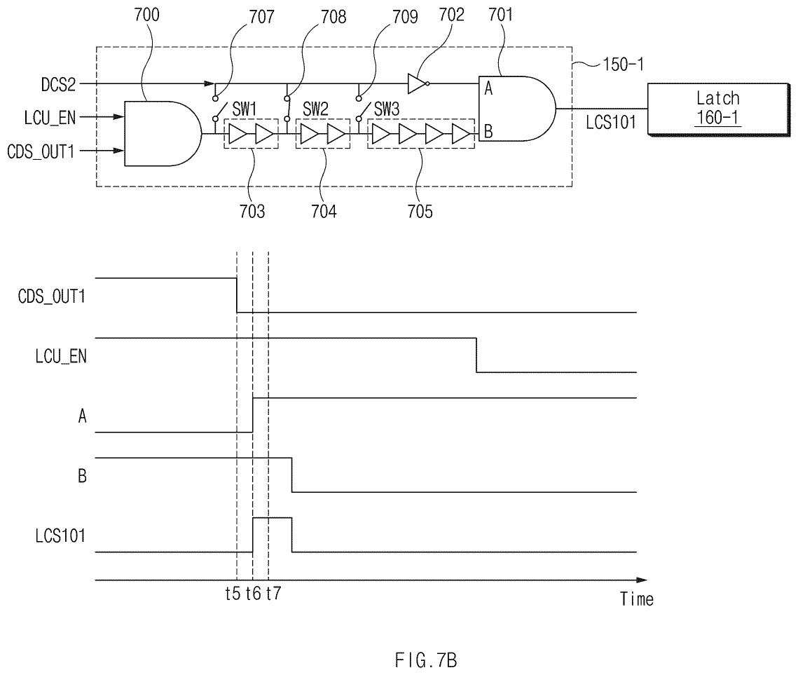

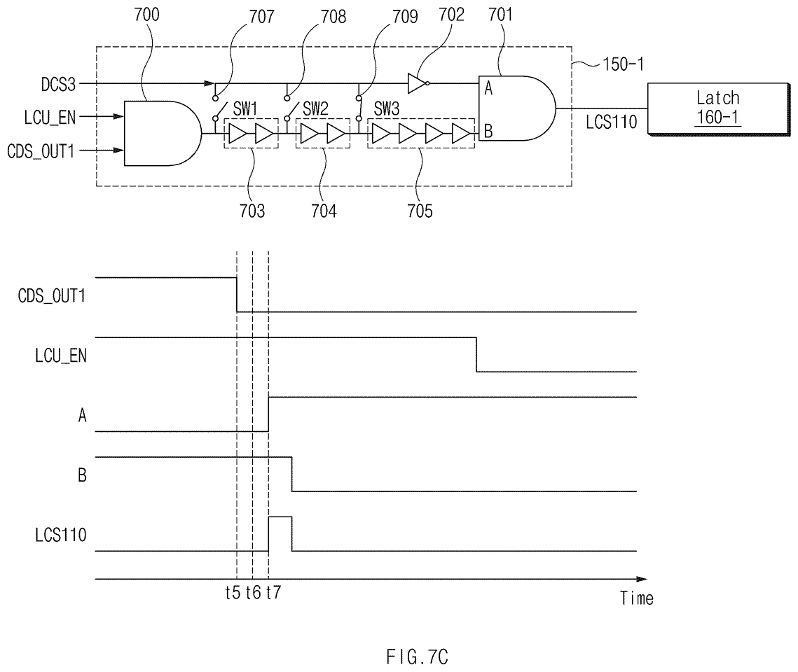

FIGS. 7A to 7C are logic circuit diagrams and timing diagrams illustrating structures and operations of the latch controllers shown in FIG. 4 based on some embodiments of the present disclosure.

Referring to FIG. 7A, the first latch controller 150-1 may receive a first classification signal (DCS1), a latch-control-unit enable signal (LCU_EN), and first comparison data (CDS_OUT1), and may output a first latch control signal (LCS100) when a first switch 707 is closed. The first classification signal (DCS1) may be generated and supplied by the timing controller 180 in response to some of the pixels corresponding to the first latch controller 150-1.

In some embodiments, the first latch controller 150-1 may include logical product elements (e.g., 700, 701), a logical negation element (e.g., 702), switches (e.g., 707, 708, 709), and signal delay cells (e.g., 703, 704, 705). For example, the first latch controller 150-1 may include two logical product elements (700, 701), one logical negation element 702, three switches (707, 708, 709), and signal delay cells (703, 704, 705), and may include information about a closed state of the first switch 707 from among the three switches.

In some embodiments, when the latch-control-unit enable signal (LCU_EN) has a logic high level and the first comparison data (CDS_OUT1) has a logic high level, the terminal (A) may have a logic low level due to the logical negation element 702 and the terminal (B) may have a logic high level due to the logical negation element 702. Thereafter, when the first comparison data (CDS_OUT11) transitions to a logic low level, the terminal (A) immediately has a logic high level. Further, the terminal (B) has a logic low level at a unit time amount after the terminal (A) immediately has a logic high level, the unit time amount being defined by 8 signal delay cells due to the signal delay cells (703, 704, 705). When the signal input to the terminal (A) and the signal input to the terminal (B) are input to the logical product element 701, a first latch control signal (LCS100) generated when the first switch 707 is closed may transition from the logic low level to the logic high level (i.e., a rising edge) at a time point (t5) where the terminal (A) transitions to the logic high level (i.e., a rising edge), and may transition from the logic high level to the logic low level at a time point where the terminal (B) transitions to the logic low level (i.e., a falling edge).

In some embodiments, the counting data is stored in each latch at a time point of the rising edge of the first latch control signal (LCS100) when the first switch 707 is closed. For example, at a time point (t5) of a rising edge of the first latch control signal (LCS100) when the first switch 707 is closed, the first latch group 160-1 may store the counting data of the first column at a corresponding bit position according to the order of digital codes. In this case, data stored in the first latch group 160-1 may correspond to pixel data of a pixel corresponding to the first classification signal (DCS1).

Referring to FIG. 7B, the first latch controller 150-1 may receive a second classification signal (DCS2), a latch-control-unit enable signal (LCU_EN), and first comparison data (CDS_OUT1), and may output a second latch control signal (LCS101) when the second switch 708 is closed. The second classification signal (DCS2) may be generated and supplied by the timing controller 180 in response to some of the pixels corresponding to the first latch controller 150-1.

In some embodiments, the first latch controller 150-1 may include logical product elements (e.g., 700, 701), a logical negation element (e.g., 702), switches (e.g., 707, 708, 709), and signal delay cells (e.g., 703, 704, 705). For example, the first latch controller 150-1 may include two logical product elements (700, 701), one logical negation element 702, three switches (707, 708, 709), and signal delay cells (703, 704, 705), and may include information about a closed state of the second switch 708 from among the three switches.

In some embodiments, when the latch-control-unit enable signal (LCU_EN) has a logic high level and the first comparison data (CDS_OUT1) has a logic high level, the terminal (A) has a logic low level due to the logical negation element 702, and the terminal (B) has a logic high level due to the logical negation element 702. Thereafter, the terminal (A) may have a logic high level at a unit time amount after the first comparison data (CDS_OUT1) transitions to a logic low level, the unit time amount being defined by two signal delay cells due to the signal delay cell 703. Further, the terminal (B) may have a logic low level at a unit time amount after the terminal (A) becomes to have a logic high level, the unit time amount being defined by 8 signal delay cells due to the signal delay cells (703, 704, 705). When the signal input to the terminal (A) and the signal input to the terminal (B) are input to the logical product element 701, a second latch control signal (LCS101) generated when the second switch 708 is closed may transition from the logic low level to the logic high level (i.e., a rising edge) at a time point (t6) where the terminal (A) transitions to the logic high level (i.e., a rising edge), and may transition from the logic high level to the logic low level (i.e., a falling edge) at a time point where the terminal (B) transitions to the logic low level (i.e., a falling edge).

In some embodiments, the counting data is stored in each latch at a time point of the rising edge of the second latch control signal (LCS101) when the second switch 708 is closed. For example, at a time point (t6) of a rising edge of the second latch control signal (LCS101) when the second switch 708 is closed, the first latch group 160-1 may store the counting data of the first column at a corresponding bit position according to the order of digital codes. In this case, data stored in the first latch group 160-1 may correspond to pixel data of a pixel corresponding to the second classification signal (DCS2).

Referring to FIG. 7C, the first latch controller 150-1 may receive a third classification signal (DCS3), a latch-control-unit enable signal (LCU_EN), and first comparison data (CDS_OUT1), and may output a third latch control signal (LCS110) when the third switch SW3 is closed. The third classification signal (DCS3) may be generated and supplied by the timing controller 180 in response to some of the pixels corresponding to the first latch controller 150-1.

In some embodiments, the first latch controller 150-1 may include logical product elements (e.g., 700, 701), a logical negation element (e.g., 702), switches (e.g., 707, 708, 709), and signal delay cells (e.g., 703, 704, 705). For example, the first latch controller 150-1 may include two logical product elements (700, 701), one logical negation element 702, three switches (707, 708, 709), and signal delay cells (703, 704, 705), and may include information about a closed state of the first switch 707 from among the three switches.

In some embodiments, when the latch-control-unit enable signal (LCU_EN) has a logic high level and the first comparison data (CDS_OUT1) has a logic high level, the terminal (A) has a logic low level due to the logical negation element 702, and the terminal (B) has a logic high level due to the logical negation element 702. Thereafter, the terminal (A) may have a logic high level at a unit time amount after the first comparison data (CDS_OUT1) transitions to a logic low level, the unit time amount being defined by four signal delay cells due to the signal delay cells (703, 704). Further, the terminal (B) may have a logic low level at a unit time amount after the first comparison data (CDS_OUT1) transitions to a logic low level, the unit time amount being defined by 8 signal delay cells due to the signal delay cells (703, 704, 705). When the signal input to the terminal (A) and the signal input to the terminal (B) are input to the logical product element 701, a third latch control signal (LCS110) generated when the third switch 709 is closed may transition from the logic low level to the logic high level (i.e., a rising edge) at a time point (t7) where the terminal (A) transitions to the logic high level (i.e., a rising edge), and may transition from the logic high level to the logic low level (i.e., a falling edge) at a time point where the terminal (B) transitions to the logic low level (i.e., a falling edge).

In some embodiments, the counting data is stored in each latch at a time point of the rising edge of the third latch control signal (LCS110) when the third switch 709 is closed. For example, at a time point (t7) of a rising edge of the third latch control signal (LCS110) when the third switch 709 is closed, the first latch group 160-1 may store the counting data of the first column at a corresponding bit position according to the order of digital codes. In this case, data stored in the first latch group 160-1 may correspond to pixel data of a pixel corresponding to the third classification signal (DCS3).

In some embodiments, a complex latch controller (not shown) may output a first latch control signal (LCS100) by matching pixels belonging to the first column of the pixel array 110 to the first classification signal (DCS1), may output a second latch control signal (LCS101) by matching pixels belonging to the second column of the pixel array 110 to the second classification signal (DCS2), and may output a third latch control signal (LCS110) by matching pixels belonging to the third column of the pixel array 110 to the third classification signal (DCS3). For example, at the time point (t5) of a rising edge of the first latch control signal (LCS100) when the first switch 707 is closed and the remaining switches (708, 709) are opened, the first latch group 160-1 may store the counting data corresponding to the first column at a corresponding bit position according to the order of digital codes. At the time point (t6) of a rising edge of the second latch control signal (LCS101) when the second switch 708 is closed and the remaining switches (707, 709) are opened, the second latch group 160-2 may store the counting data corresponding to the second column at a corresponding bit position according to the order of digital codes. In addition, at the time point (t7) of a rising edge of the third latch control signal (LCS110) when the third switch 709 is closed and the remaining switches (707, 708) are opened, the third latch group 160-3 may store the counting data corresponding to the third column at a corresponding bit position according to the order of digital codes.

In some other embodiments, a complex latch controller (not shown) may output a first latch control signal (LCS100) by matching pixels belonging to the plurality of first columns of the pixel array 110 to the first classification signal (DCS1), may output a second latch control signal (LCS101) by matching pixels belonging to the plurality of second columns of the pixel array 110 to the second classification signal (DCS2), and may output a third latch control signal (LCS110) by matching pixels belonging to the plurality of third columns of the pixel array 110 to the third classification signal (DCS3). For example, at the time point (t5) of a rising edge of the first latch control signal (LCS100) when the first switch 707 is closed and the remaining switches (708, 709) are opened, the first latch group 160-1 may store the counting data corresponding to the first column at a corresponding bit position according to the order of digital codes, and the second latch group 160-2 may store the counting data corresponding to the second column at a corresponding bit position according to the order of digital codes. At the time point (t6) of a rising edge of the second latch control signal (LCS101) when the second switch 708 is closed and the remaining switches (707, 709) are opened, the third latch group (not shown) may store the counting data corresponding to the third column at a corresponding bit position according to the order of digital codes, and the fourth latch group (not shown) may store the counting data corresponding to the fourth column at a corresponding bit position according to the order of digital codes. In addition, at the time point (t7) of a rising edge of the third latch control signal (LCS110) when the third switch 709 is closed and the remaining switches (707, 708) are opened, the fifth latch group (not shown) may store the counting data corresponding to the fifth column at a corresponding bit position according to the order of digital codes, and the sixth latch group (not shown) may store the counting data corresponding to the sixth column at a corresponding bit position according to the order of digital codes. In some other embodiments, a complex latch controller (not shown) may output a first latch control signal (LCS100) by matching a pixel including a first color filter to the first classification signal (DCS1), may output a second latch control signal (LCS101) by matching a pixel including a second color filter to the second classification signal (DCS2), and may output a third latch control signal (LCS110) by matching a pixel including a third color filter to the third classification signal (DCS3). For example, at the time point (t5) of a rising edge of the first latch control signal (LCS100) when the first switch 707 is closed and the remaining switches (708, 709) are opened, the first latch group 160-1 may store the counting data corresponding to the pixel including a red color (R) filter at a corresponding bit position according to the order of digital codes. At the time point (t6) of a rising edge of the second latch control signal (LCS101) when the second switch 708 is closed and the remaining switches (707, 709) are opened, the second latch group 160-2 may store the counting data corresponding to a pixel including a green color (G) filter at a corresponding bit position according to the order of digital codes. In addition, at the time point (t7) of a rising edge of the third latch control signal (LCS110) when the third switch 709 is closed and the remaining switches (707, 708) are opened, the third latch group 160-3 may store the counting data corresponding to a pixel including a blue color (B) filter at a corresponding bit position according to the order of digital codes.

As is apparent from the above description, the image sensing device based on some embodiments of the present disclosure can provide higher-quality images using a relatively small amount of power.

The embodiments of the present disclosure may provide a variety of effects capable of being directly or indirectly recognized through the above-mentioned descriptions.

Although a number of illustrative embodiments have been described, it should be understood that modifications and enhancements to the disclosed embodiments and other embodiments can be devised based on what is described and/or illustrated in the present disclosure.

What is claimed is:

1. An image sensing device comprising:
a latch array including:
a first latch group stores therein first image data corresponding to a first region of a pixel array;
a second latch group stores therein second image data corresponding to a second region of the pixel array;
a first latch controller generates a first latch control signal to control the first latch group; and
a second latch controller generates a second latch control signal to control the second latch group,
wherein a second edge of the second latch control signal occurs after a first edge of the first latch control signal.

2. The image sensing device according to claim 1, wherein:
the first region includes a first column of the pixel array and
the second region includes a second column of the pixel array.

3. The image sensing device according to claim 1, wherein:
the first edge occurs when the first latch control signal transitions from a logic low level to a logic high level, and
the second edge occurs when the second latch control signal transitions from a logic low level to a logic high level.

4. The image sensing device according to claim 1, wherein a pulse width of the first latch control signal and a pulse width of the second latch control signal are different from each other.

5. The image sensing device according to claim 1, wherein the first latch controller and the second latch controller are activated by a same control start signal.

6. The image sensing device according to claim 1, wherein the first latch controller includes:
a plurality of signal delay cells each delays a start time of an input signal; and
a variable switch adjusts a time point of an edge of the first latch control signal such that different pixel groups included in the first region correspond to edges at different time points.

7. The image sensing device according to claim 6, wherein the variable switch adjusts the time point of the edge of the first latch control signal by adjusting the number of signal delay cells corresponding to the first region in response to a classification signal.

8. The image sensing device according to claim 6, wherein each of the plurality of pixel groups includes pixels electrically connected to the same analog-to-digital converter (ADC).

9. The image sensing device according to claim 6, wherein each of the plurality of pixel groups includes pixels corresponding to the same color.

10. An image sensing device comprising a latch array including:
a first latch group stores therein first image data corresponding to a first region of a pixel array; and
a second latch group store therein second image data corresponding to a second region of the pixel array,
wherein the second latch group stores therein the second image data after the first latch group stores therein the first image data.

11. The image sensing device according to claim 10, wherein:
the first region includes a first column of the pixel array, and
the second region includes a second column of the pixel array.

12. The image sensing device according to claim 10, wherein:
the first latch group is further configured to receive a first latch control signal indicating a start time point of storing the first image data, and
the second latch group is further configured to receive a second latch control signal indicating a start time point of storing the second image data.

13. The image sensing device according to claim 12, wherein the first latch group is further configured to receive classification signals to adjust start time points of storing therein a plurality of data groups included in the first image data such that the first latch group stores therein the plurality of data groups at different time points.

14. The image sensing device according to claim 13, wherein the classification signals are for determination of the start time points of storing the plurality of data groups in the first latch group.

15. The image sensing device according to claim 13, wherein each of the plurality of data groups includes data pieces corresponding to the same analog-to-digital converter (ADC).

16. The image sensing device according to claim 13, wherein each of the plurality of data groups includes pixel data pieces of pixels corresponding to the same color.

17. An image sensing method comprising:
detecting, by a first latch group included in a latch array, a first edge of a first latch control signal;
storing, by the first latch group, first image data corresponding to a first region of a pixel array;
detecting, by a second latch group included in the latch array, a second edge of a second latch control signal; and
storing, by the second latch group, second image data corresponding to a second region of the pixel array at a time point delayed from a storage time at which the first image data is stored.

18. The image sensing method according to claim 17, wherein the storing the first image data includes:
receiving a first classification signal; and
receiving a second classification signal.

19. The image sensing method according to claim 18, wherein the storing the first image data further includes storing a first data group included in the first image data in response to the first classification signal.

20. The image sensing method according to claim 18, wherein the storing the first image data further includes storing, after the storing the first data group, a second data group included in the first image data in response to the second classification signal.
